(19) United States
(12) Patent Application Publication
(10) Pub. No.: US 2017/0282858 A1
(43) Pub. Date: Oct. 5, 2017

(54) Keyless Entry Systems

(71) Applicant: Continental Automotive GmbH, Hannover (DE)

(72) Inventor: Dieter Sass, Regensburg (DE)

(73) Assignee: Continental Automotive GmbH, Hannover (DE)

(21) Appl. No.: 15/510,702

(22) PCT Filed: Sep. 7, 2015
(86) PCT No.: PCT/EP2015/070328

§ 371 Date: Mar. 13, 2017

(30) Foreign Application Priority Data
Sep. 11, 2014 (DE) 10 2014 218 213.1

(51) Int. Cl. B60R 25/24; H01Q 1/32; G07C 9/00

(52) U.S. Cl. CPC B60R 25/24; E05B 81/77; G07C 9/00309; H01Q 1/3241; H01Q 1/3283; B60R 2325/103; G07C 2009/00365; G07C 2009/00404

(57) ABSTRACT

The present disclosure relates to an arrangement and a method for detecting the approach of an object and the teachings thereof may be embodied in a system for providing passive keyless vehicle access. A device may include: a communication device with an antenna to generate an electromagnetic field at regular intervals in a polling mode; and a processor to determine at least one operating parameter of the antenna whenever an electromagnetic field is generated, to compare the at least one determined operating parameter with a corresponding previously determined operating parameter, wherein a change in the at least one operating parameter indicates that an object is approaching the device, and to emit a signal if the comparison reveals that an operating parameter has changed.

### CROSS-REFERENCE TO RELATED APPLICATIONS

This application is a U.S. National Stage Application of International Application No. PCT/EP2015/070328 filed Sep. 7, 2015, which designates the United States of America, and claims priority to DE Application No. 10 2014 218 213.1 filed Sep. 11, 2014, the contents of which are hereby incorporated by reference in their entirety.

### TECHNICAL FIELD

The present disclosure relates to an arrangement and a method for detecting the approach of an object and the teachings thereof may be embodied in a system for providing passive keyless vehicle access.

### BACKGROUND

Many vehicles can nowadays be unlocked or locked with a keyless entry system. Keyless vehicle access and starting systems, for example the Passive Start Entry (PASE) system, are automated systems for unlocking a vehicle without active use of an automobile key and may include the option to start a vehicle by merely actuating the start button. Systems for keyless vehicle access are also referred to as keyless entry systems, for example.

In some examples, the driver carries an electronic key with a chip. As soon as the driver's hand comes within a few centimeters of the door handle of an accordingly equipped vehicle, this approach is detected by a proximity sensor (for example optical or capacitive). The system then wakes up from a standby mode and PASE communication is started. During PASE communication, the access system in the vehicle emits a query signal coded using a first coding table at an LF frequency (LF stands for “low frequency” with frequencies between 20 kHz and 200 kHz, for example) to check the authorization of the electronic key. The access system then changes to a receiving mode in the UHF range (UHF stands for “ultra high frequency” with frequencies in the three-digit MHz range, for example) and waits for a response. If a key equipped with a transponder is in range, it receives the LF signal, decodes it, and emits it again with new coding as a UHF signal using a second coding table. The UHF signal is decoded in the vehicle. Since the vehicle knows both coding tables, it can compare its own original emission with the response signal just received and can grant access if they match. If there is no correct response within a defined time, nothing happens and the system switches to the standby mode again. Pulling the door handle does not have any effect in this case and the vehicle remains locked.

A capacitive proximity sensor for detecting the approach of an object may include a so-called sensor electrode which forms one electrode of a capacitor. A grounded object entering the detection region of the sensor is used as the counter-electrode of the capacitor. If an object (for example the driver's hand) approaches the sensor, the capacitance of the capacitor formed by means of the sensor electrode and the counter-electrode changes. The change in the capacitance is determined directly or indirectly by means of evaluation electronics, for example by means of dual-slope methods (conversion of the capacitance into a frequency) or charge/discharge methods (measurement of the charging and discharging times of the capacitor), and is compared with a predefined triggering criterion, from which the evaluation electronics infer the presence or absence of an object in the detection region. In addition, the distance between the object and the sensor can also be determined. Such a sensor arrangement is described, for example, in the publication DE 10 2011 012 688 A1.

Such a system includes various components, for example a sensor and corresponding evaluation electronics. The requisite components comsume space in the vehicle and increase costs for manufacturing and/or maintenance.

### SUMMARY

The teachings of the present disclosure may be embodied in systems that can detect the approach of an object, in particular when an object approaches a vehicle, using as few components as possible.

Some embodiments may include an arrangement having a communication device (4) which has an antenna (41). The antenna (41) may be designed to generate an electromagnetic field at regular intervals in a polling mode. The communication device (4) may be designed to determine at least one operating parameter of the antenna (41) whenever an electromagnetic field is generated, to compare the at least one determined operating parameter with a corresponding previously determined operating parameter, a change in the at least one operating parameter indicating that an object (6) is approaching the communication device (4), and to emit a signal if the comparison reveals that an operating parameter has changed.

In some embodiments, the communication device (4) may be a near field communication device.

In some embodiments, the at least one determined operating parameter may be an amplitude of a voltage at the antenna (41) or a phase angle between a voltage at the antenna and a current through the antenna (41).

Some embodiments may include a control device (3), the control device (3) being designed to receive the signal from the communication device (4) and to start passive start entry communication when it receives the signal.

In some embodiments, the communication device (4) also may be designed to change to a standby mode after a polling mode, in which standby mode the antenna (41) does not generate an electromagnetic field.

In some embodiments, the antenna (41) may be designed to determine the at least one operating parameter every 25-50 ms.

In some embodiments, the communication device (4) may be arranged in a vehicle. In some embodiments, the communication device (4) may be arranged in a door handle, on a window, on a wing mirror, or in the B-pillar of the vehicle.

Some embodiments may include a method for detecting an object (6) including: generating an electromagnetic field at regular intervals by means of an antenna (41) in a communication device (4); determining at least one operating parameter of the antenna (41) whenever an electromagnetic field is generated; comparing each determined operating parameter with a previously determined operating parameter, a change in the at least one operating parameter indicating that an object (6) is approaching the communication device (4); and emitting a signal if the comparison reveals that an operating parameter has changed.

### BRIEF DESCRIPTION OF THE DRAWINGS

The invention is explained in more detail below using the embodiments illustrated in the figures, in which:

FIG. 1 shows a block diagram of an arrangement having a proximity sensor;

FIG. 2 shows a block diagram of two communication devices for near field communication, according to teachings of the present disclosure;

FIG. 3 schematically shows the sequence of an NFC method in a state transition diagram, according to teachings of the present disclosure;

FIG. 4 shows a block diagram of an arrangement having a communication device, according to teachings of the present disclosure;

FIG. 5 shows a block diagram of a further arrangement having a communication device, according to teachings of the present disclosure;

FIG. 6 schematically shows the sequence of a method for granting access in a state transition diagram, according to teachings of the present disclosure; and

FIG. 7 shows a flowchart of a method for granting access to a vehicle, according to teachings of the present disclosure.

### DETAILED DESCRIPTION

In some embodiments, the arrangement for detecting the approach of an object may include a communication device which has an antenna to generate an electromagnetic field at regular intervals in a polling mode (query mode). The communication device may determine at least one operating parameter of the antenna whenever an electromagnetic field is generated, compare the at least one determined operating parameter with a corresponding previously determined operating parameter (a change in the at least one operating parameter indicating that an object is approaching the communication device), and emit a signal if the comparison reveals that an operating parameter has changed. In this case, the previously determined operating parameter may be an operating parameter determined immediately beforehand or an operating parameter which was previously determined at any desired time but is not the operating parameter determined immediately beforehand.

A communication device can therefore be used as a proximity sensor which can detect the approach of an object, since different operating parameters of an antenna generating an electromagnetic field change when an object moves into the electromagnetic field.

In some embodiments, the communication device emits the signal only when the comparison of the determined operating parameter and the corresponding previously determined operating parameter reveals that the operating parameter has changed by an amount greater than or equal to a predetermined threshold amount. This ensures that a signal is emitted only in the case of an appropriate (large) change in the operating parameter, and smaller fluctuations, for example caused by the environment and/or system, are not taken into account.

The communication device may be a near field communication device (NFC device). Near field communication devices have already been provided for various other functions in vehicles, for example. Therefore, there is no need for any additional proximity sensors and associated evaluation units. The at least one determined operating parameter may be an amplitude of a voltage at the antenna or a phase angle between a voltage at the antenna and a current through the antenna.

The arrangement may also include a control device to receive the signal from the communication device and to start PASE communication when it receives the signal. The arrangement can therefore be used as a proximity sensor in a system for providing keyless vehicle access. The authorization of a vehicle key in the vicinity can be checked using PASE communication, for example. If a valid vehicle key is in the vicinity, access to a vehicle can then be granted, for example. For this purpose, the communication device may be arranged in a vehicle. In the vehicle, the communication device may be arranged, for example, in a door handle, on a window, on a wing mirror, or in the B-pillar of the vehicle.

The communication device may also change to a standby mode after the polling mode, in which standby mode the antenna does not generate an electromagnetic field. This makes it possible to save energy since the electromagnetic field is not continuously generated. The practice of saving energy is an important criterion, in particular in vehicles in which the components are supplied from the vehicle battery.

In some embodiments, the arrangement may determine the at least one operating parameter every 25-50 ms. An approach of the hand of a user wishing to open a vehicle door can thus be detected, for example, and access to the vehicle can be provided without the user noticing any delays.

In some embodiments, NFC-enabled communication devices are already present for various other applications in vehicles. Additional sensors are, therefore, not required and costs can be reduced as a result.

In some embodiments, a method for detecting the approach of an object may include: generating an electromagnetic field at regular intervals by means of an antenna in a communication device; determining at least one operating parameter of the antenna whenever an electromagnetic field is generated; comparing each determined operating parameter with a previously determined operating parameter, a change in the at least one operating parameter indicating that an object is approaching the communication device; and emitting a signal if the comparison reveals that an operating parameter has changed.

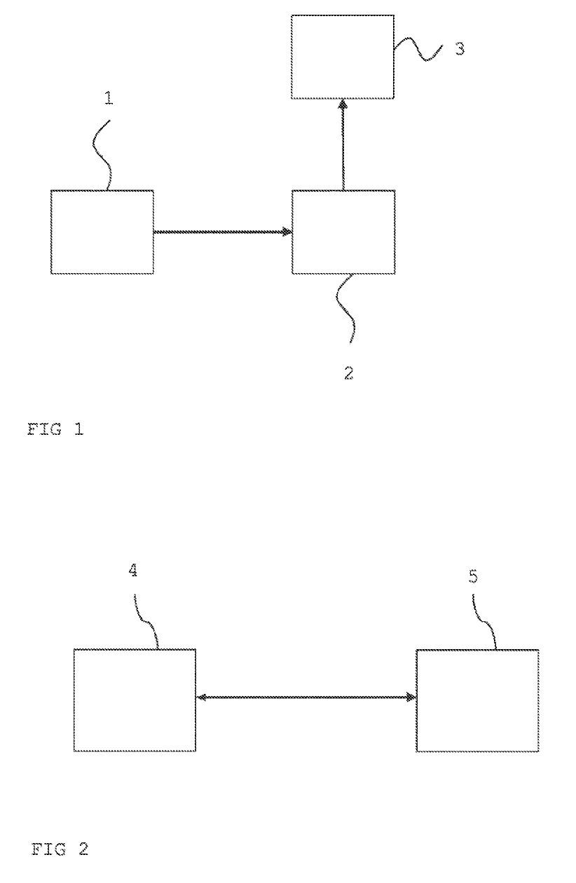

FIG. 1 illustrates a block diagram of an arrangement having a proximity sensor 1. The proximity sensor 1 may be, for example, a capacitive or optical proximity sensor 1 which is designed to determine particular parameters. In the case of a capacitive proximity sensor 1, a parameter may be a capacitance, for example. A capacitive proximity sensor 1 may include a so-called sensor electrode forming a first electrode of a capacitor. A grounded object entering the detection region of the sensor is used as the counter-electrode of the capacitor. If an object (for example the driver's hand) approaches the sensor, the capacitance of the capacitor formed by means of the sensor electrode and the counter-electrode changes.

The determined parameters are delivered an evaluation unit 2. The change in the capacitance is determined in the evaluation unit 2 directly or indirectly, for example by means of dual-slope methods (conversion of the capacitance into a frequency) or charge/discharge methods (measurement of the charging and discharging times of the capacitor), and is compared with a predefined triggering criterion, from which the evaluation unit 2 infers the presence or absence of an object in the detection region. If the presence of an object at a particular distance from the proximity sensor 1 is detected, the evaluation unit can provide a control device 3 with a corresponding signal. The control device 3 can then start PASE communication (PASE=Passive Start Entry).

During PASE communication, the control device 3 emits a query signal coded using a first coding table at an LF frequency (LF stands for “low frequency” with frequencies between 20 kHz and 200 kHz, for example) in order to check the authorization of an electronic key. The control device 3 then changes to a receiving mode in the UHF range (UHF stands for “ultra high frequency” with frequencies in the three-digit MHz range, for example) and waits for a response. If a key equipped with a transponder is in range, it receives the LF signal, decodes it and emits it again with new coding as a UHF signal using a second coding table. The UHF signal is decoded in the control device 3. Since the control device 3 knows both coding tables, it can compare its own original emission with the response signal just received and can grant access if they match. If the control device 3 does not receive a correct response within a defined time, nothing happens and the arrangement switches to the standby mode again. Pulling the door handle does not have any effect in this case and the vehicle remains locked.

Such an arrangement has the disadvantage that a proximity sensor 1 and an evaluation unit 2 are required in addition to components already present in the vehicle for other functions.

The so-called near field communication, NFC for short, is nowadays used for various functions in the vehicle (for example vehicle start authorization, vehicle status display on the mobile telephone, automatic WiFi or Bluetooth pairing, or vehicle personalization). NFC makes it possible to contactlessly interchange data between devices over a distance of a few centimeters. Up to 424 kbits/s can be transmitted using NFC.

The block diagram in FIG. 2 shows a first communication device 4 arranged in a vehicle and a second communication device 5. The second communication device 5 may be arranged, for example, in a smartphone or a vehicle key. The first and second communication devices 4, 5 are designed to transmit data using NFC.

In the case of near field communication, data are interchanged by means of inductive coupling between two inductances (for example antennas). In this case, the inductance of one communication device acts as a so-called initiator and the inductance of the other communication device acts as a so-called target. The electromagnetic fields radiate from the initiator to the target at a frequency of 13.56 MHz.

The state transition diagram in FIG. 3 schematically illustrates the sequence of an NFC method. A first communication device 4 in the vehicle cyclically changes to a so-called polling mode (state A). The first communication device 4 generates an electromagnetic field in this polling mode. While the first communication device 4 is in the polling mode, it is possible to detect whether there is an object in the vicinity. If an object is not detected during the polling mode, the first communication device 4 changes to a standby mode (state B). The first communication device 4 does not generate an electromagnetic field in the standby mode. The first communication device 4 then changes to the polling mode again and a new cycle begins.

If an object, which may be an NFC-enabled second communication device 5, is detected during the polling mode, the first communication device 4 changes to an active mode (state C). In this active mode, the first communication device 4 first checks various NFC protocols. It may emit signals according to various NFC standards in succession and wait for a response. Mobile NFC-enabled communication devices 5, for example smartphones, generally use only one of a number of known NFC standards. In contrast, a communication device 4 in the vehicle can generally communicate according to all known standards. If the first communication device 4 does not receive a response to any of the signals, this means that there is no NFC-enabled device 5 according to a valid standard in the vicinity. The first communication device 4 then changes to the standby mode (state B) again before a new cycle begins with the next change to the polling mode (state A).

If the first communication device 4 receives a valid response to a signal, an NFC-enabled device 5 according to a valid standard was detected (state D). The first communication device 4 then begins transmission with this device (state E). Once the transmission has been concluded, the first communication device 4 changes to the standby mode (state B) before a new cycle begins with the next change to the polling mode (state A).

The first communication device 4 has an antenna which generates an electromagnetic field for interchanging data with the second communication device 5. The electromagnetic field emitted by the first communication device 4 in the vehicle uses the present invention to detect the approach of an object. An NFC device 4, which is already present for other functions in the vehicle, therefore replaces the additional (for example optical or capacitive) proximity sensor.

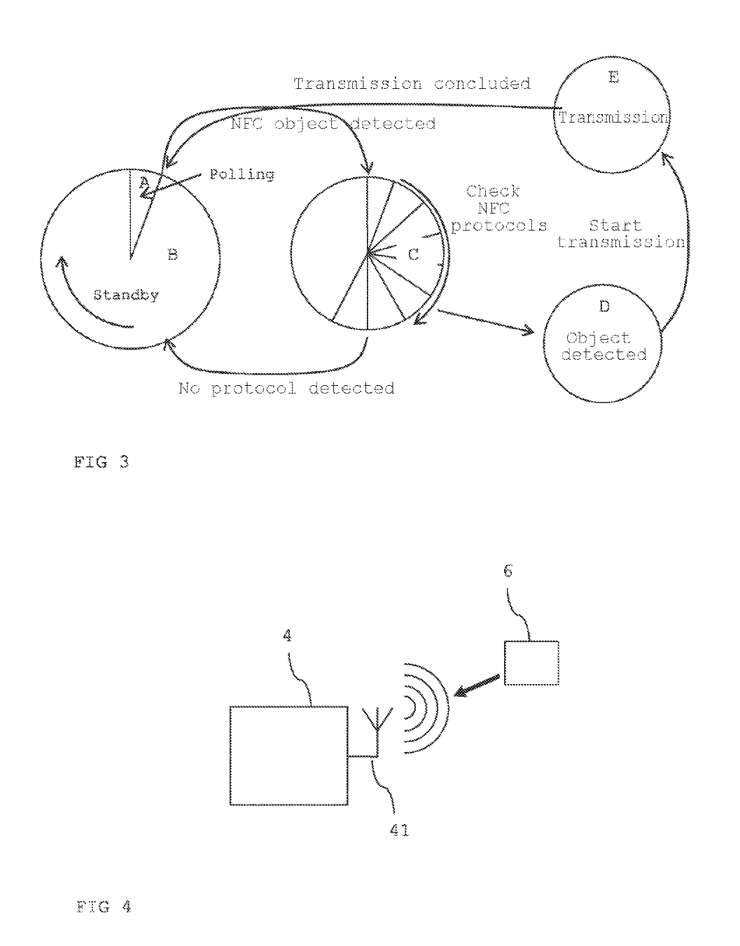

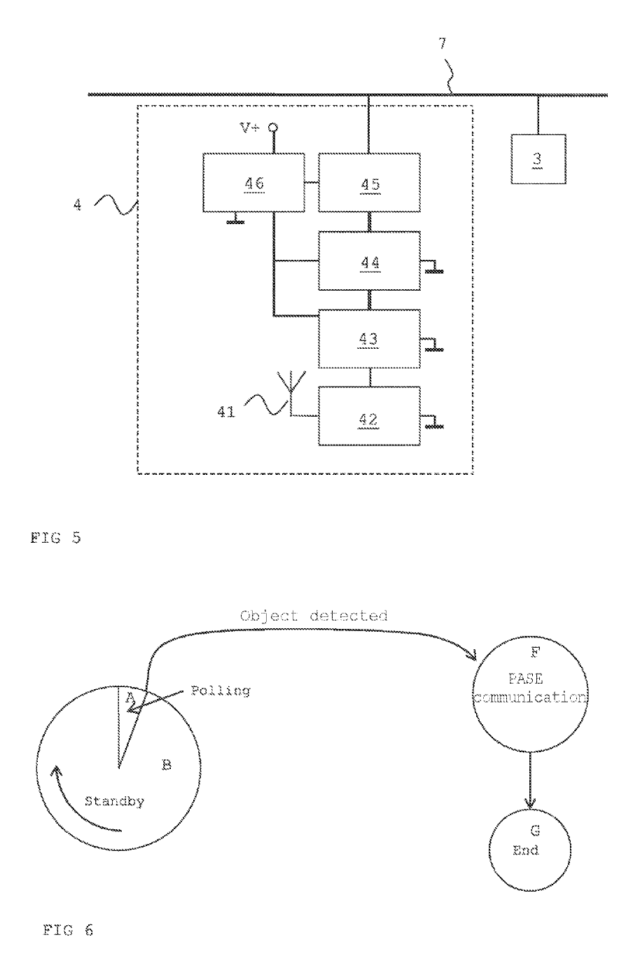

This is illustrated, by way of example, in the block diagram in FIG. 4. The first communication device 4 has an antenna 41. The antenna 41 generates an electromagnetic field which is illustrated by semicircles in FIG. 4. If an object 6 moves into the electromagnetic field, various operating parameters of the antenna change. The antenna 41 comprises a coil, for example. If a current which changes over time flows through the coil, a magnetic flux which changes over time is produced around the coil. If an object 6 moves into the electromagnetic field, the amplitude of a voltage across the antenna 41 changes, for example, since active power is drained from the electromagnetic field (so-called eddy current losses). Instead of or in addition to the amplitude of the voltage, the phase angle between the voltage at the antenna and the current in the antenna 41 may also change if an object 6 moves into the electromagnetic field. The approach of an object 6 therefore causes, with a predefined first operating parameter (for example current in the antenna 41), a change in a second operating parameter of the antenna (for example voltage or phase angle).

Irrespective of the cycle described above (cyclical transition to the polling mode from the standby mode), the first communication device 4 can record at least one operating parameter at regular intervals (for example every 25-50 ms). The first communication device 4 can then compare the recorded value with a previously determined value of this operating parameter. For this purpose, the recorded values of the operating parameters can each be stored for a particular time in the communication device 4. A change in the operating parameters indicates the approach of an object 6. If the approach of an object 6 is detected, PASE communication can then be started, as described above, in order to check whether a valid transponder (for example vehicle key) is in the vicinity and the vehicle is opened.

The block diagram in FIG. 5 shows, by way of example, a possible implementation of a communication device 4. The communication device 4 has an antenna 41 for generating an electromagnetic field.

An antenna front-end 42 is connected to the antenna 41 and is designed to set the frequency of the electromagnetic field generated by the antenna 41. A basic device 43 connected to the antenna front-end 42 is designed, for example, to generate the electromagnetic field and to demodulate a received signal. The basic device 43 therefore undertakes the tasks of a transmitter and a receiver.

A microcontroller 44 is connected to the basic device 43. The microcontroller 44 may send commands to the basic device 43. The microcontroller 44 transmits a signal, for example, via a bus interface 45 when the approach of an object has been detected. The bus interface 45 is connected between the microcontroller 44 and a vehicle bus 7. The vehicle bus 7 may be, for example, an LIN bus (LIN=Local Interconnect Network) or a CAN bus (CAN=Controller Area Network). Signals can be transmitted between various control devices in the vehicle via the vehicle bus 7. If the approach of an object is detected, a corresponding signal can be transmitted to a control device 3, for example. The control device 3 is designed to carry out PASE communication. The various components of the communication device 4 are connected, on the one hand, to a reference potential GND and, on the other hand, to a voltage regulator 46. The voltage regulator 46 is connected to the reference potential GND and to a connection for a positive potential V+ and is designed to provide a supply voltage for the components of the communication device 4. The supply voltage may be 3 V, for example.

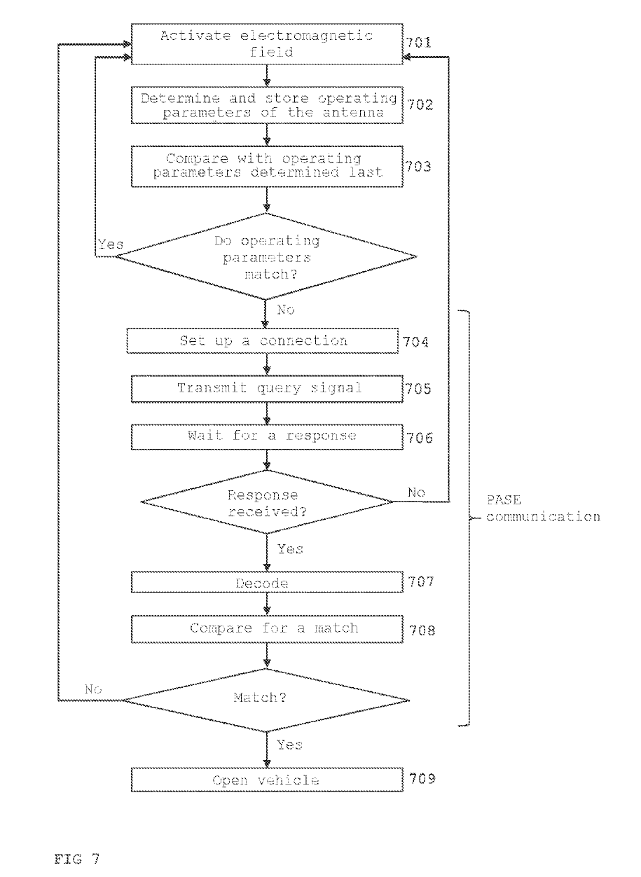

The state transition diagram in FIG. 6 schematically illustrates the sequence of a method for granting access using an NFC communication device 4. As already described above, the first communication device 4 in the vehicle cyclically changes between a polling mode (state A), in which an electromagnetic field is generated, and a standby mode (state B), in which an electromagnetic field is not generated. If a change in at least one operating parameter is detected in the antenna 41 during the polling mode, that is to say if an object 6 is detected, PASE communication is started (state F) and a search is carried out for a valid vehicle key in the vicinity of the vehicle. In this case, the PASE communication is independent of the NFC communication described with respect to FIG. 3. If an object 6 is detected in the electromagnetic field (which does not necessarily have to be an NFC-enabled device), PASE communication, for example, can be started even before the first communication device 4 begins to query the NFC protocols (as described with respect to state C in FIG. 3). However, it is also possible for PASE communication to be started during or after querying the NFC protocols. If either a valid vehicle key is detected or a valid vehicle key is not detected within a particular time, the PASE communication is ended (state G).

FIG. 7 shows a flowchart of a method for providing access to a vehicle, for example. In this case, whenever the first communication device 4 generates the electromagnetic field (step 701), various operating parameters of the antenna 41 are determined (step 702). These operating parameters are stored and are compared with previously determined operating parameters (step 703). In this case, previously determined operating parameters may be operating parameters determined immediately beforehand or operating parameters which were previously determined at any desired time but are not the operating parameters determined immediately beforehand. If the operating parameters match the previously determined operating parameters, there is no object in the electromagnetic field. The method then begins again in step 701 with the generation of the electromagnetic field. As described with respect to FIG. 3, however, the first communication device 4 can first change to a standby mode (not illustrated in FIG. 7) for a particular time before it generates the electromagnetic field again.

If the determined operating parameters do not match the previously determined operating parameters, but rather differ from them by a predefinable minimum amount, there is an object 6 in the electromagnetic field. This may be the hand of a user, for example. However, it is also possible for the object 6 to be an NFC-enabled communication device 5 or else raindrops, for example. The detection of the approach of an object 6 triggers the start of PASE communication which is carried out by a corresponding control device 3, for example. The control device 3 attempts to set up a connection (step 704) and emits a query signal for this purpose (step 705). The control device 3 then waits for a response (step 706). If the control device 3 does not receive a response to the query signal, that is to say if there is no key in range, the PASE communication is aborted. The method then begins again in step 701 with the generation of the electromagnetic field.

If the control device 3 receives a response, it decodes this response (step 709) and checks whether it is a valid response. In this case, the control device 3 compares its own original emission with the signal just received (step 708). If there is no match, that is to say if there is no valid vehicle key in range, the PASE communication is aborted. The method then begins again in step 701 with the generation of the electromagnetic field. If a match is determined, a valid key is in range and the vehicle is opened (step 709).

NFC communication devices 4 may be arranged at a wide variety of locations in the vehicle. For example, communication devices 4 may be arranged in the door handle. This arrangement may be advantageous since, at this position, it is possible to detect whether a user is reaching for the door handle to open the vehicle. However, communication devices 4 may also be arranged on windows, for example. This may be advantageous since communication devices 4 arranged on the inside of windows are well protected there from rain, wind, dust or other environmental influences. However, other positions in the vehicle, for example in the B-pillar or the wing mirror, are also possible. If the communication device 4, and therefore the proximity sensor, is not fitted in the door handle, a user must move his hand, for example, over the corresponding location (for example on the side window) since NFC can only be used to detect objects 6 at a distance of a few centimeters.

The use of an NFC communication device 4 which is already in the vehicle for other functions has the advantage that no additional (capacitive or optical) proximity sensor 1 and no corresponding evaluation electronics 2 is required. The method therefore manages with components which are already provided for other functions.

### LIST OF REFERENCE SYMBOLS

1 Sensor
2 Evaluation unit
3 Control device
4 First communication device
5 Second communication device
6 Object
7 Vehicle bus
41 Antenna
42 Antenna front-end
43 Basic device
44 Microcontroller
45 Bus interface
46 Voltage regulator
A-G States
701-709 Method steps

What is claimed is:

1. A device comprising:
a communication device with an antenna to generate an electromagnetic field at regular intervals in a polling mode; and
a processor
to determine at least one operating parameter of the antenna whenever an electromagnetic field is generated,
to compare the at least one determined operating parameter with a corresponding previously determined operating parameter, wherein a change in the at least one operating parameter indicates that an object is approaching the device, and
to emit a signal if the comparison reveals that an operating parameter has changed.

2. The device as claimed in claim 1, wherein the communication device comprises a near field communication device.

3. The device as claimed in claim 1, wherein the at least one determined operating parameter comprises an amplitude of a voltage at the antenna or a phase angle between a voltage at the antenna and a current through the antenna.

4. The device as claimed in claim 1, further comprising a control device to receive the signal from the communication device and to start passive start entry communication when it receives the signal.

5. The arrangement as claimed in claim 1 wherein the communication device
changes to a standby mode after the polling mode, in which standby mode the antenna does not generate an electromagnetic field.

6. The device as claimed in claim 1, wherein the antenna determines the at least one operating parameter at least once every 25-50 ms.

7. The device as claimed in claim 1, further comprising the communication device disposed in a vehicle.

8. The device as claimed in claim 7, further comprising the communication device arranged in a door handle, on a window, on a wing mirror, or in the B-pillar of the vehicle.

9. A method for detecting an object the method comprising:
generating an electromagnetic field at regular intervals with an antenna associated with a communication device;
determining at least one operating parameter of the antenna whenever an electromagnetic field is generated;
comparing the at least one determined operating parameter with a previously determined operating parameter, and interpreting a change in the at least one operating parameter as indicating that an object is approaching the communication device; and
emitting a signal if the comparison reveals that an operating parameter has changed.
